(19) United States
(12) Patent Application Publication
(10) Pub. No.: US 2015/0254910 A1
(43) Pub. Date: Sep. 10, 2015

(54) METHOD OF SAILBOAT PERFORMANCE ANALYSIS ON RACE MAPS USING TACKING DISTANCES AND REAL-TIME WIND MAPS

(71) Applicant: Craig Summers, Halifax (CA)

(72) Inventor: Craig Summers, Halifax (CA)

(21) Appl. No.: 14/635,358

(22) Filed: Mar. 2, 2015

Related U.S. Application Data
(60) Provisional application No. 61/948,210, filed on Mar. 5, 2014.

(51) Int. Cl. G07C 5/00

(52) U.S. Cl. CPC G07C 5/008

(57) ABSTRACT

On sailboats of any size, it is now possible to have advanced navigation using ordinary mobile devices. By sharing one's wind data and receiving data from other internet-enabled anemometers, micro-weather maps can be used to assess tacking routes, even through multiple wind zones. Crowd-sourced real-time wind maps are better than generic weather forecasts. GPS data can also be easily shared without special equipment, for performance analysis or viewing race standings in real time or replays. Methods are disclosed for polar plot learning to determine optimal tacks. The performance of other boats can also be assessed based on boat speed, GPS location, heading, wind speed and wind direction, with no polar plots needed. Rather than advantage lines or VMG, a method is disclosed for calculating tacking distances to display a novel indicator of projected Completion Time and standings for boats on a race map.

### PRIORITY CLAIM

The present non provisional patent application claims priority under 35 USC §119(e) from U.S. Provisional Patent Application having Ser. No. 61/948,210, filed Mar. 5, 2014, entitled “Method of Sailboat Performance Analysis on Race Maps Using Tacking Distances and Real-Time Wind Maps,” the entirety of which is incorporated herein by reference in its entirety.

### FIELD OF INVENTION

The invention concerns an improved method of calculating the standings of sailboats in a race, using maps of wind and GPS data shared wirelessly during the race or transmitted later for analyzing replays.

### BACKGROUND

Dedicated sailboat race trackers are available for monitoring boat positions, from companies like YellowBrick Tracking Limited of Southampton, England or YachtBot manufactured by Igtimi Limited of Dunedin, New Zealand. These waterproof boxes can collect data from onboard electronics, and transmit by satellite for monitoring race progress (or radio frequency or cellular data if within range). However, it is expensive and inconvenient to use special transponders on a sailboat for race monitoring. The YellowBrick device uses Iridium satellites the same as satellite phones, for low-bandwidth two-way email, texting, and other data such as GPS map positioning. But with widespread use of internet-enabled smartphones and tablets, it would be less expensive and more convenient if there were a way to share wind and race data using ordinary mobile devices, whether with real-time cellular data connections or transmitting stored GPS and wind data later when a wireless network like wifi is available.

The longstanding America's Cup sailboat races use the most advanced sailing technology, and spare no expense. As White (2012) notes “In many ways the history of sailing instruments and software is a history of the Americas Cup as most of the major developments were driven by AC requirements and resources.” The 2013 America's Cup regatta with hydrofoiling catamarans in San Francisco was by far the fastest, most technologically-advanced in the history of the regatta back to 1851. In the lead-up to the 2013 television broadcasts, Brustein (2012) noted that “New data and graphics will provide television viewers a better sense of the race's progression during the America's Cup . . . . White lines appear at regular intervals, and blue lines mark the boundaries of the pitch, turning a patch of open water into something resembling a nautical football field” These white lines were overlaid onto the video of the water in a method known as augmented reality. The sailors could not see the lines, but the television viewers could. The horizontal lines showing progress to a waypoint are sometimes referred to as a “ladder”, with the historical assumption that the sailboat that gets up the rungs (lines) of the ladder fastest will be the winner. But this is not necessarily true, since the sailboat's finishing placement depends on its speed, heading and tacking geometry. With sailboats, it is not a linear race. Diamond or V-shaped laylines are typically used for the outer boundaries of the ladder. But these generic laylines would be different for each boat, and could only be correct if they were based on the polar plots for individual sailboats.

A related concept is the “advantage line”, which is an imaginary line shown off the bow of the leading boat or multiple boats. The line is parallel to the finish line, and is intended to simply show which sailboat is ahead on a line perpendicular to the finish line. Unfortunately, there are times as shown in FIG. 1, when it is not correct. In FIG. 1, Boat A is higher up the ladder than Boat B, suggesting it is in the lead. But Boat A actually has substantially farther to travel than Boat B, aside from each boat's speed. The advantage line is an oversimplification that is not always a good indicator of the actual standings in a race. The problem is that the ladder rungs extend infinitely in either direction. So being on a higher ladder rung does not mean that you are closer to the finish line, or will finish earlier. Being on a higher ladder rung does not take into account your speed and tacking distances. That is a problem.

Virtual Eye is a commercial product from Animation Research Ltd. of Dunedin, New Zealand that creates 3D animations of live sailboat races and replays, which have been used in America's Cup broadcasts. According to their web site: “Virtual Eye can show an entire race course, including marks, laylines, advantage lines and distances between the boats. Virtual Eye also displays timing information from starts, mark rounding and finishes” (Virtual Eye, 2014). A Virtual Eye (2009) corporate brochure includes screenshots where the software draws an advantage line parallel to the finish line, and shows how far behind this line one boat is than another.

A mobile app called RaceQs (2014) is available in iTunes (from Apple Inc. of Cupertino, Calif.) that has a similar function, drawing lines parallel to the finish line across the front of two different boats, and displaying the number of meters between the boats. Unfortunately, even if one boat is ahead on this version of the advantage line ladder, that doesn't mean they are going to get there first (which is the important question).

### Velocity Made Good (VMG)

The problem with simply looking at which sailboat is higher up the ladder was noted by McLain (1989) twenty-five years ago: “In most racing events the shortest route between two points is the fastest. This is definitely not true when racing yachts” (2nd paragraph of Background). Similarly, even when a sailboat can sail in a straight line to a waypoint, such as when the waypoint is directly downwind, Polsky (1978) noted that: “the selected position may in many instances be reached more quickly by tacking” (paragraph 2 of Description). Since displaying “who is closer to the finish line” does not account for the fact that sailboats often tack diagonally to a destination, Velocity Made Good (VMG) is a more sophisticated indicator that has been traditionally been used by sailors.

Weather routing programs have been developed for well-financed offshore sailboat race teams. Traditionally weather-routing programs were designed to allow the navigator to plan ahead with large-scale weather systems. Their focus is on finding the best tacking route for long ocean passages and forecasted weather systems, to get to the destination fastest. They were designed to be used with large-region weather forecasts, although real-time wind maps would obviously be better. They use VMG. For example, the Advantage weather-routing software from Brayshaw (2014) “shows you at a glance where you can make the best “velocity made good” towards the mark”.

Deckman is one of the oldest weather-routing programs, and set the standard: “B&G Deckman, the world's most advanced race navigation software. Deckman represents B&G's commitment in providing software of the highest quality and performance” (B&G 2005, p. 1.1). As Nick White, the developer of the Expedition weather-routing software, notes in his historical summary of the industry: “Graeme Winn started Deckman in 1987. By 1988, he had added isochronal routing using wind, current and tide . . . . Weather routing using grib files was added in early 1997 for the upcoming Whitbread race, although it already had weather routing using user defined winds.” Its' purpose is to “give you the quickest route between the two selected marks, given any wind and tide information” (B&G 2005, p. 3.14). The detailed Owner's Manual (B&G 2005) uses polar plots to obtain the Velocity Made Good, but there is no mention of using distance for calculating optimal routes. For example, on p. 6.2 it notes that “v1 is the boat speed at point 1 and a1 is the wind angle. The first point (v1, a1) specifies the upwind target and so the maximum upwind VMG”.

VMG to a waypoint is what is typically displayed on standard GPS devices, sometimes also referred to more precisely as VMC: Velocity Made Good on Course to the mark. Standard GPS chartplotters do not determine tacking distances when calculating ETA (Estimated Time of Arrival) for sailboats. Using the vector of progress towards the waypoint by subtracting movement that is off-course, seems like a clever short-cut. Then your “ETA” (Estimated Time of Arrival) could be calculated by dividing the rhumb-line distance (the straight line from the boat to the waypoint, even though sailboats don't usually travel in a straight line) by the proportion of speed in that direction (i.e., the VMG). In short, the formula is:

ETA=distance/VMG to the mark

For a historical example, Buckley (1987) provides a good illustration of VMG being used to calculate ETA in his book Racing Through Paradise. He describes a 1982 trip where he first saw ETA calculated. That was before GPS became available, using LORAN (Long Range Aids to Navigation), a land-based predecessor to GPS satellites:
“You ask it for an Estimated Time of Arrival. It tells you, in about two seconds, “ETA 2142”. What it has done is taken the speed you have made good over the preceding five minutes in the direction of your waypoint. It has then divided the speed into the distance between where you are now and where the waypoint is toward which you are headed, and added this to the time of day. The answer is 9:42 PM. I confess that the first time I had this experience I simply sat and started at the computer, in dumb admiration” (p. 29)

Unfortunately, although VMG to the waypoint may have been better than nothing in the days when only a few calculations could be done in a bouncing, heeled-over sailboat using a slide-rule, it is not a reliable measure of velocity for sailing in the digital age. Even if your speed and heading remain constant, VMG decreases further for every second you are tacking away from the rhumb line (the direct line to your destination). That is like having a speedometer in a car that decreases all by itself as you drive down the road at a constant speed.

In the decades before the internet, personal computers, GPS or powerful smartphones, VMG seemed like it may be a good solution for the traditional sailor's dilemma, of how far off the wind to head when sailing to an upwind mark. In U.S. Pat. No. 4,107,988, Polsky (1978) follows this logic in comparing VMG to the mark for two routes, which he illustrates in his FIG. 1. The basic logic is theoretically correct: if you were able to compare VMG to the mark for two different tack headings while at the same position, it could be determined that one route is better than the other. Unfortunately, in practice Polsky (1978) does not use polar plots for boat speed, and relies on actual boat speeds from a knot meter, which means that the two comparisons are from different locations, which contaminates the results. Polsky notes that in the 1970s, it was not easy to do “speed made good” (i.e., VMG) calculations repeatedly, or quickly enough to use for navigation:
“Although the speed made good . . . may be manually calculated using the speed of the vessel through the water as read from a knot meter, the compass reading and the direct course as inputs, such calculations are not readily available and do not permit prompt course corrections in order to maximize the speed made good” (paragraph 3 of Description section).

Without data showing a record of VMG to the mark as the boat continued on a tack, he was unable to see from the diagram in his FIG. 1 that VMG to a mark would drop all by itself the longer a tack continued, even if the boat speed and heading remained constant.

Others such as McLain (1989) and Hirst (1990) had the same problem when attempting to devise custom slide rules to do the calculations while under sail. The McLain (1989) patent is an interesting historical example of how VMG to the mark came into widespread use, even though it later became clear in the GPS era that the actual calculations were unreliable and illogical on sailboats. McLain uses a complex arrangement of 7 different rotating dials on a circular slide rule. Like Polsky, McLain was apparently not aware that VMG to the mark decreases the longer you stay on a tack, which only really becomes apparent when you can continually recalculate it while the boat moves (e.g., using a modern GPS chartplotter or charting app). McLain's calculations and device are too cumbersome to have allowed continuous calculations, to make the user aware of the errors from VMG to the mark.

As LORAN and GPS technology arrived, the marine electronics manufacturers took this questionable measure of “velocity”, and have been calculating ETA with it ever since. That is fine in aircraft, vehicles and powerboats, which expect to travel in a straight line to their destination. But for sailboats, this leads to the bizarre result that as the boat tacks closer to the destination, the ETA displayed is actually increasing. Completely unacceptable. Different results are also displayed if the boat uses long tacks or short tacks, even if the distances and boat speeds are identical with long or short tacks. That should not happen.

Amazingly, expensive modern GPS chartplotters now on the market still use VMG to the mark for sailboat navigation, even though the precise distances for each tack would be easily available in a GPS.

For example, the User Manual for B&G's Zeus GPS chartplotter (2010, p. 57) states that it is using “Velocity Made Good towards next waypoint” (not to the wind). B&G is the sailboat electronics manufacturing division of the Navico multinational conglomerate, which started in the 1950s in England making radio direction-finders as Brookes and Gatehouse. The Guide for their GPS chartplotter further explains that that “by sailing along your target laylines you can maximize your Velocity Made Good (VMG)” (B&G, 2011, p. 11). B&G's 240-page Instrument Handbook also includes this example of how they use polar plots to derive VMG: “The Boat Speed on the curve at this point is, by definition, the Target Boat Speed for that True Wind Speed, the True Wind Angle at that point becomes the Target TWA. The two combined allow us to calculate VMG performance” (2009, p. 131).

VMG to the mark erroneously gives the illusion that you are heading increasingly off-course or slowing down, even if your speed and heading remain constant (Summers, 2009). Even if you are sailing on the correct tack to a waypoint, standard GPS chartplotters view the tack as cross-track error. Hardly an acceptable or even safe method, for sailboat navigation.

Brayshaw (2001) observes this artifact with VMG decreasing away from the rhumb line, but assumes that it reflects actual boat performance and is not just an error in the geometry: “Away from the rhumbline, the isochromes curve downward to right and left, indicating the boat will make slower progress there” (p. 45). Not true; the boat could still be on the correct tack and maintaining exactly the same heading and speed, yet the VMG will continue to fall on its own because it is not a valid measure (Summers, 2009). In the age of GPS where boat tracks can easily be overlaid on a chart, it is now widely accepted that VMG to the mark is an erroneous measure of performance on sailboats. As noted by Ockam (2014): “VMG is not a usable helming function”.

Here is another example of this common mistake:
“Roy taught me how valuable the VMG (Velocity Made Good to a point) on the GPS can be in a Cruising Rally. As the wind would swing around to be more from the southeast or east and we would have to tack or bear off to maintain our boat speed, our VMG to Bermuda would drop dramatically to where even though our boat speed through the water was 5.5 to 6.0 knots, our VMG would drop to only 1.6 to 2.0 knots . . . . Sailing it would take 4.3 hours to cover 7 miles” (Williams, 2002).

Williams assumes that the VMG to the mark is correct, as it drops down to 1.6 knots of boat speed. But this is not true. Then, when dividing the 7-mile distance along the rhumb line by 1.6 knots of speed in that direction, he calculates that the ETA=7/1.6=4.3 hours. As shown in Summers (2009), that division is not true; VMG would continue to drop lower (and even into negative numbers) the longer the boat stayed on a tack. The ETA would appear to get longer and longer as the remaining tacking distance actually got shorter and shorter, which does not make sense.

Many sailors assume that all parameters on an expensive GPS chartplotter must be correct and precise, since the device can pinpoint your exact location on earth. But VMG to the mark gives illogical results that are not meaningful for sailboat navigation. The method was used on slide rules before personal computers existed, before the world wide web, before smartphones and tablets, and before GPS existed. Unfortunately, it is now clear that these measures of VMG and ETA do not account for the intentional tacking or zig-zagging that sailboats do.

Putting VMG in the denominator when calculating ETA is like adding a random number there. As shown in Summers (2009), the calculation can be done, but the results are not meaningful. Hence, some of the major manufacturers appear to have traditionally blanked out ETA when the sailboat continues on a tack for too long, knowing that the VMG becomes too unreliable and that the ETA becomes meaningless and potentially even poses a liability issue for the manufacturer. Not a very good solution. Better to make the instrument correct, than to stop the driver from being able to see it. In the digital age, sailors deserve a better solution.

### VMG to the Wind has Different Problems

One of the traditional responses to the problems with VMG is that you should measure VMG relative to the wind direction, not relative to a waypoint. But even with VMG into the wind, there are a lot of assumptions. VMG to the wind gets messed up every time the wind shifts. It only tells you your accurate progress towards the waypoint when the waypoint is directly upwind. Say you are on the final upwind leg of a race. You want to know your relative speed towards the finish line. But what if the wind shifts and is not directly behind the waypoint anymore? Unfortunately, there is no indication that this is happening or how erroneous it is (especially when you are off the rhumb line on a tack). VMG to the Wind is then showing your relative speed in other directions that are not towards the finish line.

VMG to the wind also cannot be used on legs of sailboat races across the wind, because this VMG will show a speed of zero if you are not making progress against the wind. So even with VMG to the wind, whenever you sail across the wind you may need to still use VMG to the mark.

VMG measures are also only available while you are underway, based on your speed and heading. Also, as a measure of speed, they do not show the distance on a tack, or whether you are on the optimal tack.

Even if you assessed ETA using VMG to the wind, there is still a fundamental problem. The trigonometry in this method only tells you when you have crossed an imaginary line going through the destination at a particular angle to the wind direction. That line extends for miles in each direction (infinitely, actually). So there is no way to tell if you have the best tacking angle to the actual waypoint, or how long it will take to get there.

Even though there is a big difference in the results with VMG to the mark or to the wind, for some reason most products do not make clear which type of VMG is being displayed. This is like having a speedometer in your car that doesn't tell you if it is measuring in miles or kilometers per hour. (Although at least a speedometer measures consistently, unlike VMG to the mark. That is even more reason that the type of VMG should be specified.) For example, marine electronics manufacturer B&G has a web site for state of the art sailing tactics, B&G's Academy for sail training. It provides a Glossary of sailboat navigation terms, where B&G (2014) specifies that standard GPS chartplotters display VMG to the mark (sometimes called VMC) rather than into the wind: “If you see “VMG” on a GPS unit, it is really VMC”.

Typifying the confusion from the traditional marine electronics manufacturers, the same Glossary then provides a contradictory definition of “VMG” as “A measure of your speed towards the wind” (B&G, 2014). This is so completely circular and incoherent that it rivals comedy skits from the Marx Brothers or Monty Python.

Thus, the existing methods and products have serious flaws for sailboat navigation. A clear, reliable solution that correctly indicates which boats are in the lead during sailboat races and their relative Completion Times would be very useful.

### SUMMARY

Contrary to the range of methods that have been used over the years in races like the America's Cup, in GPS chartplotters, and in weather-routing software, an alternative method disclosed here is novel and even heretical; a method that is simpler yet gives more accurate results concerning the performance and likely placement and Completion Times of sailboats in a race. VMG and advantage lines showing who is closer to the finish line do not account for the tacking distances of sailboats. The sailboat's performance is not simple to assess, because it depends on the interaction or tradeoff between the boat's speed and its distance. Sometimes called the Helmsman's Dilemma, even experienced skippers cannot do mental trigonometry and additional comparisons to determine the optimal course, when trying to find the optimal balance between speed off the wind and minimizing distance upwind. The method and calculations required to define the optimal route or to compare boats to see which has the more optimal route are not obvious.

Although there are a number of detailed steps involved in the method disclosed here, in the big picture, this new conception of Completion Time calculates the distance on each tack, uses the sailboat's current speed on the tack or average speed for a recent period to assess how long it will take the boat to arrive, compares this to other boats' placement, and provides a graphical display of the boats' standings and/or Completion Times. There are no products using this method. It is different from the use of advantage lines and any form of Velocity Made Good. The logic is so inherently clear and simple, that it may make existing manufacturers and those skilled in the art say “Why didn't I think of that?”. As will be shown in the preferred embodiment section below, the method disclosed here calculates the tacking distance based on the wind angle and uses the boat speed to then calculate the Completion Time, to compare each boat in the race. It was not possible to locate the boats precisely on a race map in real time, before the days of LORAN and GPS, when VMG and advantage lines were conceptualized. But there is no reason we need to stick with those limitations in the age of digital electronics and GPS.

The method disclosed here produces more accurate results with surprisingly parsimony. In science, Occam's Razor is a valuable heuristic, using the simplest available method that provides the greatest explanatory power. In this case, it is not even that we have two competing methods that provide the same results, so that we should use the simpler and more efficient one; the simpler method disclosed here actually provides better results. Rather than the flaws of displaying advantage lines, ladders or VMG, we can display a number on each boat on a race map indicating their standing or projected Completion Time, or indicate these standings in a list or even with color coding or other visual patterns or graphics on the race map.

Beyond all of the details of implementing the invention disclosed here, it ultimately comes down to a simple mathematical principle. “If” we can calculate the tacking distances simultaneously for all of the different sailboats in a race (which is not easy in itself), we can divide distance by boat speed to obtain their Completion Times. Calculating travel time using this quotient is a well-known mathematical formula. For example, if a town is 100 miles away and a car travels at 50 miles per hour, 100/50=2 hours to get there. But while the mathematical logic of distance over time is easy to comprehend, applying it to the trigonometry of sailboat tacking is not. The method disclosed here for sharing wind data, sharing GPS data on boat speed and location, and deriving wind angles to project where the tack will be and the total distance of the tacking legs, to then derive the Completion Time and projected race time and placement, is an inventive application of the mathematical principle of distance over speed. It is different from existing methods, and has a useful purpose.

### Wind Maps

Dedicated satellite trackers have only been installed on boats in major races. There has been no easy and low-cost way to do this until now. But we are now in the era of GPS and mobile handheld computers that many sailors have with them, even on small centerboard sailboats in waterproof cases. For boats that were too small for marine electronics, having a smartphone in your pocket allows GPS tracking, chartplotting, weather updates and emergency calls. Even a dinghy sailboat can be internet-enabled now. In a race, it is therefore possible to share wind and GPS data from the boat and to receive updates on the race. Although Summers (2013) filed a Provisional patent on a wireless anemometer, there is a further new possibility for networking the wind data, so that others can also use it for planning optimal tacks. It is not just wireless from the masthead to the receiving device, but from the boat to the internet. Even older wired anemometers can be on a network that is internet-enabled, contributing data to real-time wind maps. Then, race organizers can see wind maps from the judges' boat, for placing race marks directly upwind. Racing teams can also see or replay wind maps from internet-enabled anemometers around the course for performance analysis.

If wind data is being provided via a wireless format such as radio, cellular or satellite data from anemometers around the course, suddenly a detailed real-time wind map becomes possible. Then, instead of a weather forecast made hours ago by a meteorologist at an airport far away, you have real-time wind data from out on the water. If enough people and locations were providing data from anemometers, crowd-sourced wind data could provide rich map coverage of real-time wind trends, with better wind information than forecasts from other sources like the government or broadcasters. That makes tack planning much more precise. If you want to do performance analysis after a sailboat race, having maps, records and animations of actual wind data also gives you a much better result. For a racing team, it is then possible to know the exact conditions when comparing the performance of multiple boats.

Along with the benefits of real-time wind maps over stale forecasts, networked anemometers would also make it possible to have graphs of wind speed and direction. You could look at the trends right now, either for planning sailing routes or because you are at home or office and wondering if the winds are good for going out on the water. You could also look back at a graph or a map animation, to see a replay, either when broadcasting a race or analyzing it later.

This approach does not require that the anemometer can provide its own internet connection, but just that a mobile or computing device with internet access can share the information. That could be when the user is on board with a wireless device like a smartphone or tablet that is internet-enabled. Or it could be with an Internet connection in the vessel (or from a land-based anemometer), so that even if the skipper is away, the skipper or even the public could check the wind conditions online.

Race Maps This new internet connectivity is also democratizing race maps now. This does not have to be the purview of only major races like the America's Cup. It is not necessary to get sponsors, so that you can install a tracking device in your sailboat, to share positions from all of the boats in a race.

The SailTimer app produced by SailTimer Inc. of Halifax, Canada already lets users graph the day's wind data. It also lets the user display, save or share their GPS tracks and GPS location. The next step is to let race participants share their own GPS track and wind data, so that multiple sailboats are displayed at once, with real-time or replays of GPS and wind information.

The SailTimer app is based on the 2012 US patent by Summers (U.S. Pat. No. 8,135,504), which compares various tradeoffs of boat speed (from polar plots) and tacking distances to evaluate optimal tacks and Tacking Time to Destination. This gives much more accurate tacking results than calculating ETA based on a flawed measure of VMG. It works in all wind directions, not just upwind. It also uses actual tacking distances, not inferences about how fast you are moving into the wind (which is kind of a strange approach, considering that sailboats can't ever sail directly into the wind).

Those tacking results could be shared for performance analysis on race maps, although there is an important obstacle: If polar plots are not available for each of the boats in the race, their optimal tacks and Tacking Time to Destination cannot be assessed. If we can't calculate the Tacking Time to Destination for each boat, how can we determine the standings of each during the race?

Fortunately, the method disclosed here provides an important inventive step that overcomes this problem. The key is that polar plots are not needed to assess other boats and who is in the lead; only for determining the optimal tacks on one boat. But for comparing across boats, we can just use the boat speed and tacking distance to project Completion Time, for evaluating who is winning and the overall standings.

This is an inventive application of the standard mathematics for travel time=distance/speed. However, the method disclosed here is not that generic formula, it is a specific application to the problem of how to determine the standings of sailboats in a race. It is also a novel approach that does not use any form of VMG, is better than simply considering who is ahead with an advantage line, does not simply look at boat speed, and does not require the polar plots for a particular boat or comparison of various possible routes for a boat. So if this method of comparing performance using each boat's Completion Time could be shown on race and wind maps to indicate the standings of each boat, it would be a novel approach that would be very useful.

Further objects and advantages of the present invention will be apparent from the descriptions in the following sections wherein preferred embodiments of the invention are shown.

### BRIEF DESCRIPTION OF THE FIGURES

FIG. 1: The boat that is higher on a ladder or advantage line may not be the one with the fastest Completion Time based on tacking points, distances and boat speed.

FIG. 2: Determining tacking point and distances on tack 1 and tack 2.

FIG. 3: Using wind map to find best part of course.

### DETAILED DESCRIPTION

In the method disclosed here, data can be transmitted and shared, directly between users or via an internet connection or server, to display wind data and also boat positions on a map. More details will be provided in the subsections below, although in the preferred embodiment this could happen in real-time, or later for replay analysis. This could allow:
Users on one boat to get other information needed, such as wind maps or other boat positions, for planning their own tacking routes.
Others to observe or replay sailboat races and wind conditions.
Sailing teams to assess conditions around the course for practice purposes.
Race officials to plan where to drop anchors for the placement of the marks in a race.

In a preferred embodiment, you could also check online to see wind conditions from home or office. This approach does not require that the anemometer can provide its own internet connection, but just that a mobile or computing device with internet access can share the information.

Wind maps showing wind speed and direction can operate in real time in the preferred embodiment, if there are networked anemometers. These micro-weather maps can be far more detailed than ordinary weather forecasts. They also use actual wind data, not estimates. Traditional wind barb symbols are displayed in the preferred embodiment, or isobars or colored contours for wind zones. When a symbol or wind barb is clicked, more detail about the wind in that location could open. For example, those skilled in the art will know that a wind barb points like an arrow in the direction the wind is going. At the back of the wind barb are a number of ticks like feathers on an arrow, a short tick representing 5 knots of wind speed and a long tick representing 10 knots. If the “feathers” show 2 long and one short ticks, that means 10+10+5=25 knots of wind. If the wind barb or symbol for that location is clicked, a window could open with a graph of recent wind speeds and wind directions. In the preferred embodiment, if there are too many wind barbs in a particular location, the user could zoom in until they were spread out more and there were not so many in view. A special icon is used to show that there are multiple data points there.

Race maps involve displaying the GPS tracks from multiple boats, all on one map. In the preferred embodiment, we use different colors or patterns to distinguish each boat, its' track and also its' projected route if shown. In a further preferred embodiment, the sharing options include only sharing wind maps, sharing GPS information too (optionally without viewing in real time, only for later analysis), letting the public but not competitors see positions, letting anyone within a specified radius see position, or simply sharing publicly online.

### Transmissions

Users who want to receive wind data may have a wireless anemometer on board, or may want wind data because they do not have a wireless anemometer on board. In the preferred embodiment, if a user is asking for crowd-sourced wind data from other users, they would also have the opportunity to share their own data if they have an anemometer, or may even be obligated to.

In another preferred embodiment, any user who also wants to share data for wind and race maps, either contributing or viewing, would subscribe. This allows each user to have their own secure account, and allows the userbase to be quantified. In a further preferred embodiment, access to the data could be given or licensed to third-party products, but even with third-party products, this wind and race data would still require all users to subscribe, so that it became an industry standard promoted by other brands as well.

In the preferred embodiment, a wireless anemometer like the SailTimer Wind Instrument is used to provide point data, which had a provisional patent filing by Summers (2013) and which has a web page with product specifications (SailTimer Inc., 2014). Since this anemometer uses the wireless format called Bluetooth Low Energy to connect to mobile and computing devices, it is internet-enabled, and can transmit its data online to a server database through devices such as a computer, smartphone, tablet or other transmitter. But the data could also come from any wired or wireless anemometer on a boat or land station, as long as it can be connected to an internet connection.

Along with wind speed and direction, the data to be sent includes GPS location and track, as well as boat speed and heading. Data that may be available from GPS such as location, heading or speed could come from a mobile device with an internet connection, from a different GPS device in the on-board network, or could also be sent from alternate sources like a compass or speedometer. Data on tilt on all 3 axes could be sent from the anemometer (or from another device on-board), which could be useful for performance analysis regarding the progress of the boat when heeling or sailing in waves. Data on the type of anemometer could be transmitted, or added to the wind map database before it is displayed, to also assess the accuracy of the data from different types of anemometers, particularly on heeling sailboats. Data could also be sent from the anemometer on battery power and signal strength, if the anemometer and/or transmitter are wireless.

In the preferred embodiment, a cellular data connection on the sailboat or on a mobile device such as a smartphone or tablet then transmits the GPS and wind data to a database on a server. In an alternate embodiment, any other networking protocol such as ethernet, wifi, radio or LAN could work just as well to allow the data from sailboats and stationary data sources such as an anemometer at a marina to be shared either with a server or directly between multiple users.

Since a major race or regatta may have hundreds or thousands of boats and internet users all in one location, cellular data traffic may become congested. Each boat could have several people with smartphones, and some of those people could be using a lot of cellular bandwidth for streaming music or video, playing games, web browsing or video conferencing. That could cause all mobile devices in the area to all show 4 bars as if they have good signals, but with actually so little bandwidth free that no-one at all can actually use their internet connections.

In the preferred embodiment, if there are times when this happens, missing data is identified or corrected by time-stamping all data. Also, data is designed to be sent in minimal transmission sizes, both to preserve power on wireless devices and to reduce bandwidth. Also, visual indicators can be used on map displays to make clear if data is not being regularly received from boats, or if data is being interpolated between transmissions. In the preferred embodiment, a web browser or app on a mobile device can display the wind and race maps or share them with other devices onboard or transmit the data online. The mobile device can also provide GPS data and a time stamp to the app, or to a web browser using an industry standard like html5.

If the bandwidth on internet connections from the boats is congested, there are several alternatives:
1. In one embodiment, similar information about other boats' positions can be shared and transmitted on VHF radio by the Marine Automatic Identification System (AIS). Although the MS technology has only been widely available for less than a decade, it avoids the bandwidth congestion problems and need for cell towers involved with cellular data. If the onboard network contains AIS information on boats nearby, this could also be a convenient way to obtain tracking information including their latitude, longitude, heading, speed and boat name.
2. If there is network congestion on cellular data networks, as could happen in a large regatta, the preferred embodiment is for users to log their GPS data and store wind data, and later upload it to display replays.
3. In another embodiment, real-time data to the server is not restricted to only cellular data, and could also receive data from any online source, such as a satellite tracking product such as YellowBrick or YachtBot.

Of course, data networking and sharing also raises a need for secure connections, where data on each boat is clearly identified and cannot be hacked or altered. In the preferred embodiment, a password is used from the server for data from each boat. In another preferred embodiment, the data between the boat and the server online is encrypted using an industry standard such as https (Secure Socket Layer; SSL), so that no-one else can access confidential information, track competing boats or build polars for other boats without authorization or consent. In the preferred embodiment, an option is given to share the wind data without encryption for the benefit of others.

Aside from security/privacy procedures, crowd-sourcing of any kind of sensor data also raises issues in principle about ensuring the quality of the data. In the preferred embodiment, even if GPS and wind data is available for mapping from a number of sources or boats, a user or race officials may only want to select some of these data sources. In an alternate embodiment, the display can include reviews, type (e.g. on boat or stationary, brand, wired/wireless, cup/ultrasonic/propeller/other) and numbers of users of data from a particular point to help verify its' reliability.

In the preferred embodiment, the GPS data can also be used to determine if a source is moving or stationary. Or, this can simply be used in calculating and verifying data, or indicated on the map by the use of different symbols. If moving, the wind data needs to be converted from Apparent to True Wind.

If the data is coming less frequently, in the preferred embodiment it would be an option to save and transmit the average value over the time-period rather than the current wind data.

### Map Display

SailTimer Inc. of Halifax Canada has released a series of software programs based on U.S. Pat. No. 8,135,504. These calculate optimal tacks and Tacking Time to Destination. The initial versions were SailTimer for Windows and SailTimer for Google Maps in 2006, with the later release of the SailTimer app in iTunes in 2009. Recent versions of the SailTimer app allow the user to overlay their GPS track and optimal tacking angles on aerial photos, maps or marine charts. However, there has been no way to share data between multiple boats, so that a user—on another boat, or viewing online, or in later replays—could see multiple boats at the same point in time.

Polar plots are needed to determine the optimal route for an individual boat, so displaying tacking routes from all boats in a race is not as simple as just combining the GPS data and tacking results from each app user. That is an alternate embodiment, although typically racers would not want to share their tacking results. If they didn't want to share, and their polar plots weren't shared or able to be determined, there is no way to obtain their optimal tacks and Tacking Time to Destination. Fortunately, an important inventive step here is the realization that polars are not needed to determine the projected placement and Completion Time. In the preferred embodiment, the projected placement and Completion Time can be calculated by essentially comparing speed and tacking distances between the competitors. Rather than assessing race standings based on advantage lines, boat speed, or VMG, the method disclosed here uses speed and tacking distances to display projected placement and Completion Time for boats in a race.

In the preferred embodiment, multiple users would be able to receive shared wind maps. With this wind data, they could use the method from the Summers patent (U.S. Pat. No. 8,135,504) to display the optimal tacks and Tacking Time to Destination for their own vessel. In the preferred embodiment, where boats wanted to share their GPS data, it would then be possible to display the GPS tracks for other boats along with your own GPS track and tacking results. However, there is an inventive steps whereby additional information is available for your own boat, which can use polar plots to calculate optimal tacks using the method in U.S. Pat. No. 8,135,504, which can be compared with the more limited information available form other boats (which show GPS information but not optimal tacks). This does give each boat and other viewers the ability to see the locations of multiple boats. In the preferred embodiment, their GPS tracks each have different colors or patterns to make them easier to see.

Once the GPS location and tracks are displayed, with icons or 3D graphics for one or more boats and positions, in the preferred embodiment the projected Completion Time and/or finishing place can be indicated, in a table with the map or in flags, symbols, colors or icons for each sailboat on the map. The sailors and other viewers can then view graphs of wind speed, wind direction and boat location, speed and standings at various points in time. This can be viewed in real-time, or saved for later replay analysis. In the preferred embodiment there is also an option about whether to show the projected tacking legs for each boat, and an option to show the optimal tacks for one's own boat, or from others if that is being shared. It would also be possible to allow the public to view the race in real-time this way, but to also make the replays available later for the competitors and public to watch on replays or animations.

In the preferred embodiment, this type of shared wind map could also be made available for sailboats with no anemometer. That could let them generate polar plots, and get real-time wind data for calculating their own optimal tacks and Tacking Time to Destination. A sailing club or marina could also provide real-time wind data online (possibly even from multiple sources to create a map not just a single wind reading), which people could also check from home or office. In the preferred embodiment, when calculating their completion time, the race maps could also ensure that true wind data was being displayed rather than apparent wind data from a moving boat.

In an alternate embodiment, it would also be possible to generate polar plots for each individual vessel on the map by storing their boat speed on all different points of sail and wind speeds. That would also allow optimal tacks and Tacking Time to Destination to be generated for each boat, which could be compared to other similar measures or to the projected standings and Completion Time based on boat speed and tacking distance. This also could be used for assessing competitors, or in training and performance analysis.

In an alternate embodiment, the Completion Time to the starting line can be calculated, with a countdown timer for the official start time.

In an alternate embodiment, VMG, advantage lines and distances between boats (perpendicular to the finish line) can also be shown for comparison.

In an alternate embodiment, simulated boat data could also be entered, which could be useful for assessing strategies, for testing autonomous navigation, or for showing the difference in predictions between various performance indicators including VMG. Shared wind and race maps could also be used for performance analysis, training and races with remote-control boats (and simulations or sailing computer games).

In order to display these maps of wind and boats racing, in the preferred embodiment the data is sent from each source to a database in an online server. (In an alternate embodiment, the data can be shared in local peer-to-peer transmissions.) Beginning with the anemometer, in the preferred embodiment, the anemometer obtains data on wind speed and wind direction. If it is a wireless anemometer, it could transmit this (and other data on orientation, signal strength and battery levels) through the air to a mobile device using a wireless format such as Bluetooth Low Energy. Or, it could transmit in a wireless format to an accessory receiver, which could covert the signal to wifi for retransmitting, or convey the signal into a wired onboard network. The data can be displayed locally, or retransmitted, or controlled by the user locally using an app or an industry-standard format such as HTML5 in a web browser.

HTML5 is the newest industry standard at the time of writing for web browsers on computers and mobile devices, and has the advantage of being able to obtain the user's location through JavaScript geolocation functions. Functions that are now built in to HTML5 allow a web browser on a computer or mobile device to check location using sources such as GPS data available, cell tower triangulation, known wifi hotspot location or IP address when functions such as “getCurrentPosition” are called. HTML5 also supports calls in JavaScript programming for persistent local storage up to a recommended limit of 5 megabytes of data (in this case on GPS and wind-related information). This can be stored even if the browser is closed, and transmitted later if an internet connection is not currently available. So in the preferred embodiment, we can obtain position and wind information in an app (software) or web browser, and either store it until an internet connection is available, transmit locally to others, or send through an internet connection to a database on a server.

We therefore use the app or web browser to display data with wind and race maps, and also to transmit it for sharing and/or later analysis. Then anyone can use the accumulated data to see current winds with symbols and/or isobars on a map, as well as graphs showing the wind speed and direction trends over time, or animations of the displays on a map over time.

In an alternate embodiment, if the boat's heading is available or compass information, the wind data and related information such as tilt can also be displayed on a standard wind gauge display showing the wind angle around bow of boat with a numerical display of wind speed. This could be opened if an icon is clicked on the map. It could also include other information for that location or time, such as the boat's heeling and orientation in other axes while tilting with wave action. That could be useful for performance analysis. In an alternate embodiment, a speedometer display could also be used to show the wind speed, with a compass indicator showing the wind direction. As noted above, graphs of wind speed and direction could also be available; in a preferred embodiment, these could be obtained for point sources when clicking on an icon at that location.

Finally, wind maps can also be useful for other purposes. Real-time wind data is useful for the public to be able to access along with normal weather forecasts. In a preferred embodiment, the wind maps could be overlaid on weather forecast maps or integrated with normal weather forecasts. Other sub-groups may also want to access and display real-time wind maps from other sports such as archery, ballooning, flying, sharpshooting competitions and so on. In an alternate embodiment, a wind gauge could be displayed that can be rotated so the direction the user is facing is up, with compass directions around them, an arrow showing the wind that can move around them, and the wind speed shown as a number. In this embodiment, and also in the preferred embodiment with wind maps for sailing, users can have the option of displaying the arrow facing into or away from the wind. Traditionally arrows on wind vanes face into the wind, although conceptually the reference to wind direction usually show which way the wind is going.

### Performance Analysis

The displays currently in use show boat speed and who is closer on a ladder to the finish line, but those are only half of the information needed. You also need to know the tacking distance, and how the skipper is trading off boat speed and tacking distance. At first glance, it would appear that accurate polars are needed on every boat. However, polars are only needed for defining a sailboat's optimal route. When comparing boats in a race, we can assume that each boat is on its optimal tack. So in the preferred embodiment, we can simply look at its current boat speed, or average over a recent time period. There is still a question of how we calculate the distance, to then extrapolate the Completion Time and final race placement for each boat (discussed below).

In a preferred embodiment, polar plot learning and polar plots are available, at least for one's own sailboat. Then optimal tack headings and Tacking Time to Destination can then be assessed. Although it is often claimed that polars can only be theoretical targets, empirical polar data can be saved on an individual boat by storing boat speed as a function of wind speed and direction (and interpolating between the cells in the table or database). A default polar plot can be used if actual polar data is not available. The user can then define their own Tacking Time to Destination based on learned polar plots using the method of Summers (U.S. Pat. No. 8,135,504), and if polar data is available for other boats, they can all be compared. Since polars are typically not available for other boats, an inventive step in this method is to compare your own tacking results based on polars against calculations of Completion Time based on boat speed and distance for the other boats. However, in an alternate embodiment it is also possible to calculate and compare Completion Time based on boat speed and distance for one's own boat as well.

Unlike the use of GRIdded Binary (“GRIB”) weather forecast data in weather routing programs, in the preferred embodiment, real-time wind data is available second-by-second. However, in an alternate embodiment, the race standings could be assessed using the method disclosed here for calculating Completion Time, based on weather forecasts and GRIB data if real-time wind data is not available. In an alternate embodiment, this method of using actual tacking distances and boat speeds could also be used on long-distance weather routing, using forecasts, GRIB data or real-time wind data.

In the preferred embodiment, the performance and likely finishing placement of other boats (and even one's own boat, to compare using the same standard) can be assessed based on the current boat speed, GPS location, heading, wind speed and wind direction, with no polar plots needed. The high-level logic of the method is that it calculates the tacking distance based on the wind angle, uses the boat speed to then calculate the Completion Time, and compares these to assess the placement of all of the boats in a race. In more detail, the method disclosed here works for any wind direction, not just upwind, and involves the following steps:

1. Get wind angle and heading of current tack for one or more boats.

2. Calculate heading on opposite tack for the same wind angle on the other side. If boat is sailing with an average 46-degree wind angle on the starboard tack, assuming the wind stays the same, the tack heading on the opposite tack would be 46 degrees on the other side of the wind direction.

3. Get the longitude (horizontal X axis) and latitude (vertical Y axis) of current position and of waypoint.

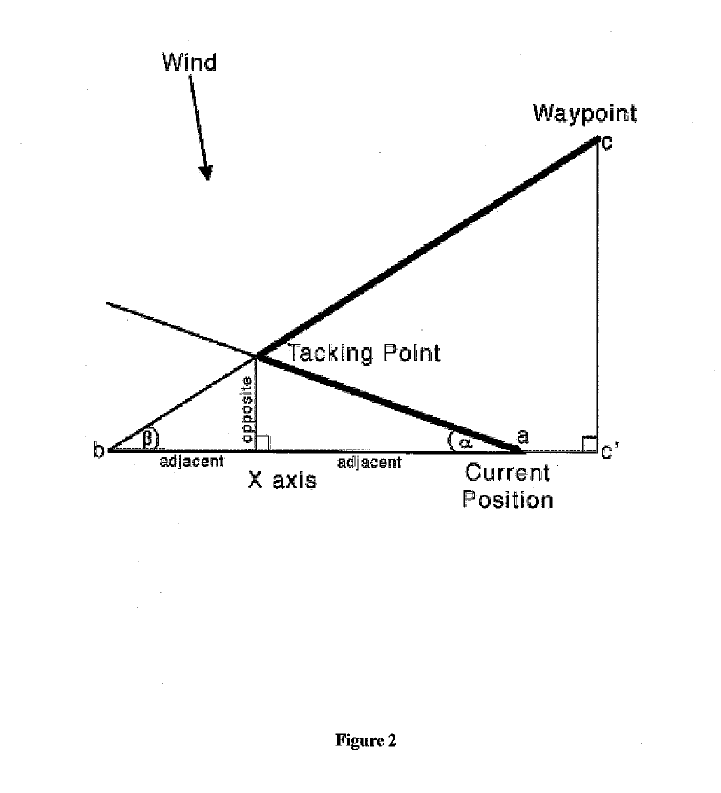

4. Extend current tack heading until the angle of the second tack intersects with waypoint. The logic is to move along the vector of the first tack, looking along the second tack to see when it intersects with the waypoint. To do so, make a right-triangle at (c′) on FIG. 2, in case the waypoint is not at the same longitude as (a), to ensure a right triangle. Using the distance from (c′) to (b) and angle beta, Tan=Opposite/Adjacent. Therefore Adjacent=Opposite/Tan. Increase the Adjacent until the Opposite equals (c)−(c′), the difference in latitude between the current position and the waypoint. It is possible to hone-in on the second tacking leg by taking larger initial jumps. Then if it becomes clear that the process went too far beyond the tacking point, it can work back towards the boat's position. This minimizes the processing required. Those skilled in the art of trigonometry will know that the same results can be derived from several alternate angles or distances that may be available for a particular set of tacks. So although we describe one preferred embodiment here, this is just one example of the logic, and the same result may be calculable using other angles and distances on the same route without departing from the spirit and scope of the invention.

5. We then want to move along the vector of tack 2 (from b to c) to obtain the tacking point, which is the only Y value (latitude) that is crossed by both tack 1 and tack 2. In one preferred embodiment, we can simply search along tack 1 using the tangent of the angle to get the latitude and longitude to compare with the latitude and longitude on tack 2 to find the same point. In an alternate preferred embodiment, the coordinates of the tacking point can be defined by using the trigonometric formula Opposite=Tan×Adjacent in the triangles of FIG. 2 with angles alpha and beta. Knowing that the Opposite side is the same in both and defines the longitude (Y value) of the tacking point, we can increase the Adjacent distance on the X axis (longitude) in both triangles until the Opposite side is the same for both. That then provides the Y value (latitude) of the tacking point from the length of the Opposite side, in relation to the Y value (latitude) of the current position (a), and the X value (longitude) of the tacking point from the distance on the Adjacent side from the current position (a).

6. Once the latitude and longitude of the tacking point has been derived, given the second tack heading and the location of the waypoint, the next step is to calculate the distance along each tack. In the preferred embodiment, using the Pythagorean Theorem of a-squared plus b-squared equals c-squared, it is possible to take the distance between the latitude and longitude to derive the distance diagonally along the hypotenuse or tacking leg. This is done for the first tacking leg, and then again for the second tacking leg, and the two distances are combined into a total distance.

7. Decide if two long tacks are preferred, or many small ones on the same headings. The distances and times are the same either way, but in the preferred embodiment more or fewer tacks can be displayed based on the user's preference. Even if the tacks are not displayed, the standings and Completion Time for each boat can be indicated.

8. Calculate the Completion Time as a function of the distance on both tacks divided by the boat speed. The boat speeds, headings, wind speed and wind direction can be averaged over a specified period. In the preferred embodiment, this could be the last 1 minute, although other periods could be used.

9. Display rank in standings and/or Completion Time on map, aerial view, race video or animation, in a table or with each boat's graphic, image or icon.

10. Clicking on the boat's graphic or data allows additional data to be viewed such as graphs.

11. GPS tracks and tack headings for one or more boats can also optionally be displayed.

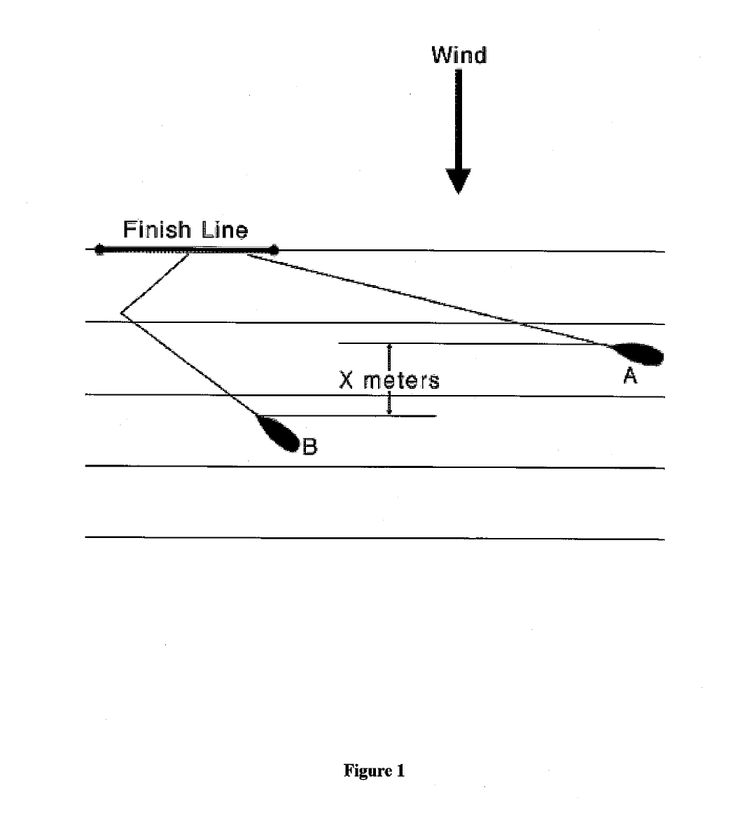

This method gives more accurate results than the ladder or advantage line used in regattas such as the America's Cup. Unlike the difference between boats on the ladder as in FIG. 1, and unlike VMG, we use actual boat speed and actual distance, not portions of speed into the wind or towards the mark. We can calculate the actual distances, and have the actual boat speed, so may as well use these instead of indirect inferences with VMG that introduce artifacts.

A further inventive step with this method is that it acts on the realization that polar data is not needed for improving the assessment of performance and race standings beyond the standard methods with VMG and advantage lines. Polar data is only needed for evaluating optimal tacks for one vessel, but current or averaged boat speed is sufficient for comparing the existing or averaged headings across all boats.

### Polar Learning

In the preferred embodiment, if polar learning is going to be used to get optimal tacks for one vessel or to compare across vessels if data on boat speed, wind angle and wind speed is available, we use the following method of data collection and interpolation which has never been disclosed before. Although there is a widespread assumption that polar plots are only theoretical “targets” that the skipper should try to attain but can not actually measure, it is actually possible to store polar data using modern digital devices. Each sample of data contains wind direction and boat heading (which together give the wind angle), boat speed and wind speed.

In the preferred embodiment, the data is monitored continuously, but only saved when certain criteria are met. These criteria can be adjusted without affecting the spirit or scope of the invention. In the preferred embodiment, the program waits for the wind speed to be constant (e.g. not varying by more than 5 knots) for a period of time (e.g. 60 seconds), and not varying in wind angle by more than a given amount (e.g. 10 degrees). If these conditions are met, we also need to ensure that the boat speed has been constant (e.g., not varying by more than 0.5 knot). The criteria for variation are all as measured by the difference between the maximum and minimum values observed during the time period. When the criteria are all met, the boat speed is then added to the appropriate “bin” (cell in a table) for wind speed/angle. Bins are used to define the range of values to catch in each interval, and to minimize any gaps between these intervals. For example, with wind speed we would want one interval to go up to 15.49 knots and the next one to start at 15.5 knots, so there is no gap that misses data. In the preferred embodiment, each bin stores the 8 best 1-minute periods observed and the boat speed value for a bin is simply the running average of these best periods.

In the preferred embodiment, a table of bins is used in which the data in each cell is the average boat speed, as a function of wind angle and wind speed. Although other values could be used, in the preferred embodiment, the rows a range of wind angles (22.5, 45.0, 67.5, 90.0, 112.5, 135.0, 157.5, 180.0) and the columns are a range of True Wind Speeds (3.0, 6.0, 9.0, 12.0, 15.0, 18.0, 21.0). The table can initially be seeded with data from a generic polar plot. It is also possible to condense the polar table to only boat speed as a function of wind angle, for users wanting to do initial or quick calculations. Conversely, in another preferred embodiment, it is also possible to build up or use more than one polar plot, for different boats, different sail combinations, for racing versus cruising, or other uses.

This data could also be expressed as points graphically on a polar plot. To smooth the lines, and to use data from in-between the cell values at each point, in the preferred embodiment we interpolate between the points. Say we have learned boat speeds for wind angles of 75 and 90 degrees and wind speeds of 12 and 16 knots. But then the boat is on a heading with a wind angle of 85 degrees and a wind speed of 14 knots. We can interpolate for the boat speed between the two different wind angles, at both wind speeds. That gives two numbers, and we the interpolate between those. So we need to do two interpolations. For example, imagine we have learned the boat speed at wind angles of 75 and 90 degrees, and they are 6.5 and 7.0 knots. Then we want the boat speed for a wind angle of 85 degrees, which is ⅔ of the way between 75 and 90 degrees. Therefore get the difference between the two corresponding speeds (7.0 knots−6.5 knots−0.5 knots), and calculate ⅔ of this, which is then added to 6.5 knots.

Finally, in the preferred embodiment the polar learning can also suspend data collection under certain conditions, which can include: when the sailboat is motoring, when the user has good data and wants to use it rather than continue adding to it, when heading into the wind, or when tacking.

### Projection Through Multiple Zones on Wind Map

If there is a different isobar so more than one wind zone is in front of one or more boats, in the preferred embodiment the boats' tacks can change to maintain same wind angle, or to choose the optimal wind angle if their polars are available.

Although long-distance ocean racing weather-routing programs sometimes divide up the trip into cells, an inventive step in the preferred embodiment is that we do not need to use cells, and can just plot new tacking angles if a new wind zone appears. In that way, the cells are dynamic in size and processing is reduced.

Ordinarily, tacks are defined between multiple waypoints on a chartplotter. But in this case, even with only one waypoint specified, there may be mini-waypoints defined on the boundaries of each wind zone, to specify new tacking results where the wind speed and direction changes.

In another preferred embodiment, the threshold is adjustable for how often or how much change in wind conditions are required before generating additional tacks and tacking distances (and therefore re-calculating Completion Times).

In the preferred embodiment, a wind map can include wind data from one or multiple anemometers, and represent these with wind barbs at each anemometer's location or with wind barbs, isocontours or color regions showing the wind data and interpolations between data sources. This can be used to generate multiple tacks through different wind zones. Traditionally that would be the overall goal of offshore weather-routing programs, using weather forecasts (not real wind data). However, it is just as effective in a small regatta where a skipper may want to know if the wind is stronger or in a different direction close to shore versus farther out in the open water. That provides a simple example where seeing a wind map helps the skipper to instantly decide on a route.

In a more complicated example, the wind map based on actual real-time wind data may help the routing software to identify the optimal route for arriving fast. For example, perhaps it is a broad reach to the finish line with no tacking if the boat sails close to shore, but additional tacks and distance farther from shore. The wind map may also make it apparent that Completion Times and standings among competitors are being affected by differences in wind around a course.

For performance analysis then, in a preferred embodiment, different competitors' projected Completion Times can be compared during a race or in later replay animations. But in an additional preferred embodiment, the wind map can be used to assess other optimal routes either for a sailboat during a race or by others assessing performance during the race or in later replay animations. Currently there is usually not a detailed enough wind map available to know about small differences in wind in different parts of a course. But wind maps like these could be used to help skippers and navigators find better wind on the course, and to show more optimal routes, either while sailing or in later assessments.

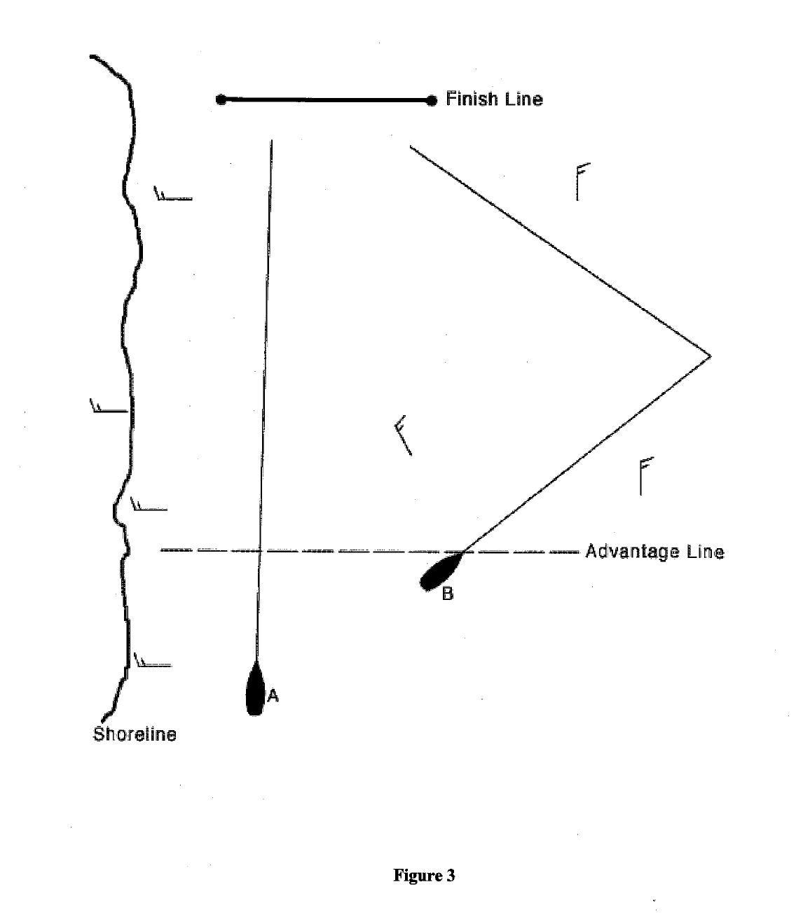

FIG. 3 illustrates how a wind map can be used to find the best winds on a course, and the advantages of the Completion Time method disclosed here over the usual method of assessing performance with an advantage line or VMG. In this example, Boat B has a speed of 7 knots, and is making a VMG of 4.5 knots. Boat A has chosen to sail close to shore, where there is an offshore breeze. That allows Boat A to sail on a broad reach, which is both their fastest point of sail and also happens to be in a straight line for the shortest tacking distance. Using traditional methods with VMG into the Wind though, Boat A would have a VMG of 0 knots, since it is making 0 progress into the wind. Clearly VMG is not providing meaningful results in this case.

Boat B is closer to the finish line than Boat A, as shown by the Advantage Line. However, the traditional assessment using the Advantage Line is clearly incorrect in this case too. Boat B may be closer, but by staying offshore is going to have to tack. The Advantage Line is giving erroneous results, since Boat A is going to finish first (even if it has a slower speed) because it has a shorter distance in this case.

Although VMG into the wind and the advantage line in FIG. 3 both indicate that Boat B should win the race, the method disclosed here of comparing the boat speed and tacking distances for each boat provide a different prediction, and make clear that contrary to the standard results with VMG and advantage lines, Boat A will have a faster Completion Time in this example based on tacking distance and speed after finding the tacking points.

The invention may be embodied in other specific forms without departing from the spirit or essential characteristics thereof. The present embodiments are therefore to be considered as illustrative and not restrictive, the scope of the invention being indicated by the appended claims rather than by the foregoing description, and all changes that come within the meaning and range of equivalency of the claims are therefore intended to be embraced therein.

### REFERENCES CITED

### US Patent Documents

| | | |
|---|---|---|
| 4,855,577 | August 1989 | McLain |
| 4,107,988 | August 1978 | Polsky |
| 8,135,504 | March 2012 | Summers |
| 61/836,870 | June 2013 | Summers (Provisional Application) |

### Other Publications

Altendorff, Russell (2010; web page). Routing 5 of 7: Algorithms. Dated Mar. 17, 2010, and viewed Feb. 8 2014. www.altendorff.co.uk/archives/1151
Brayshaw, David (2001). Increasingly Powerful—and Increasingly Relevant. Seahorse International Sailing magazine (UK), issue 258, August 2001, pages 43-46.
Brayshaw, David (2014; web page). VMG Tactical Display. Viewed Feb. 10, 2014. www.goflow.com/vmgshow.htm
B&G (2005). Deckman User Manual. B&G Ltd., Romsey, England.
B&G (2009). H3000 Instrument Handbook. B&G Ltd., Romsey, England.
B&G (2010). Zeus Multi-function Display—User Manual. Navico Holding A S, Lysaker, Norway.
B&G (2011). Zeus—Sailing Navigation, Essential Guide. Navico Inc., Tulsa Okla.
B&G (2014; web site). B&G Academy Glossary. Viewed Feb. 10, 2014. www.bandg.com/Glossary
Buckley, William F. Jr. (1987). Racing Through Paradise: A Pacific Passage. Little, Brown and Company, Boston.
Brustein, Joshua (2012). America's Cup Updates As it Trawls for Viewers. The New York Times (online, published Jun. 27, 2012). Viewed Jul. 10, 2012. www.nytimes.com/2012/06/28/sports/americas-cup-seeking-bigger-audience-changes-its-rules.html?_r=2&pagewanted=all&goback=%2Egde_{—}2247966_member_{—}131000046&
Hirst, John Christopher (1990). V.M.G. (Velocity Made Good) Comparator. UK Patent Application 8816428.0. Filed January 1988, published January 1990.
Ockam (2014; web page). OckamSoft Functions: Performance. Viewed Feb. 11, 2014. Ockam Instruments Inc., Milford, Conn. www.Ockam.com/funcperf.html
RaceQs (2014). Online video showing raceQs iPhone app. Viewed Jan. 8, 2014 at https://www.facebook.com/photo.php?v=504760542955647&set=vb.340813212683715&type=2 &theater
SailTimer Inc. (product web site). The next-generation SailTimer Wind Instrument™ for 2014. Viewed Feb. 8, 2014. www.SailTimerWind.com
The Story of Virtual Eye Sailing (product homepage). Viewed Jan. 25, 2014. http://virtualeye.tv/index.php/the-sports/virtual-eye-sailing
Summers (2009). Bad News for Velocity Made Good. GAM on Yachting magazine, May-June issue, pages 26-30.
Virtual Eye Sailing (November 2009). Corporate brochure in PDF format, viewed Feb. 21, 2014. Available from www.virtualeye.tv/media/ve_sailing.pdf
Virtual Eye (2014; web site). The Story of Virtual Eye Sailing. Viewed Feb. 21, 2014. www.virtualeye.tv/index.php/the-sports/virtual-eye-sailing
White, Nick (2012; web page). A Brief History of Sailing Instruments and Software Over the Decades. Viewed Dec. 20, 2012. www.expeditionmarine.com/history.htm
Williams, Dalton (2002; web page). “West Marine Bermuda Cup”, viewed Feb. 17, 2014. www.svquietly.com/ShipsLog/Bermuda %20Cup/Bermuda %20Cup.htm

What is claimed:

1. A method of sharing wind and GPS data for calculating and displaying the standings of sailboats in a race, using the boats' current wind angle and speed to calculate tacking distances and Completion Time.

2. The method of sharing wind and GPS data for calculating and displaying standings of sailboats in a race in claim 1, wherein wind maps comprised of symbols showing wind speed and direction at different points where boats and stationary wind sensors are, may include wind barbs or arrows and wind speeds at the point source, with averages of wind barbs if there are too many in view, and isobar contours dividing different wind zones.

3. The method of sharing wind and GPS data for calculating and displaying standings of sailboats in a race in claim 1, wherein wind maps from multiple networked anemometers allow calculations and comparisons to a waypoint, finish line or starting line, of Completion Time for some or all boats in a race, and/or optimal tacks using the Summers US patent (U.S. Pat. No. 8,135,504) using different patterns, colors or indicators to distinguish current tacks from optimal.

4. The method of sharing wind and GPS data for calculating and displaying standings of sailboats in a race in claim 1, wherein real-time wind maps can be checked online before deciding to go out sailing, and sailboats with no anemometer can also get real-time wind data from other boats sharing wind data and other sources including sailing clubs and marinas with stationary networked anemometers, to calculate tacking results based on Summers US patent (U.S. Pat. No. 8,135,504) and Completion Times based on distance and speed, and generate polar plots from one or more anemometers.

5. The method of sharing wind and GPS data for calculating and displaying standings of sailboats in a race in claim 1, wherein the tacking legs can be shown for multiple boats based on current wind angles or based on optimal tacks using polar plots as in Summers US patent (U.S. Pat. No. 8,135,504), which may change as they pass through different wind zones.

6. The method of sharing wind and GPS data for calculating and displaying standings of sailboats in a race in claim 1, wherein data from weather forecasts and GRIdded Binary (GRIB) data can also be displayed on the map and used in tacking calculations, or used where real-time wind data is not available, with visual indicators of the two types of sources.

7. The method of sharing wind and GPS data for calculating and displaying standings of sailboats in a race in claim 1, wherein Completion Time can be calculated for any wind direction not just upwind, to give a more accurate indicator of performance and standings in a race than advantage lines, ladders or VMG, comprising the steps of:
a. getting wind angle and heading for current tack;
b. getting heading on opposite tack for the same wind angle on the other side;
c. getting longitude (horizontal X axis) and latitude (vertical Y axis) of current position and of waypoint.
d. extending further along the longitude or X axis (or following the same logic along the latitude or Y axis) until the second tack intersects with waypoint;
e. determining when the second tack intersects with the waypoint, which can be calculated numerically using the angle beta of tack 2 and the distance on the X axis from the waypoint, to calculate the Y value using the standard trigonometry formula Tan=Opposite/Adjacent, transformed to Opposite=Tan×Adjacent to get the latitude;
f. when the Y value (longitude) of this calculation equals the Y value of the waypoint (or is specified to be within an acceptable range), the second tack is passing through the waypoint;
g. getting the coordinates of the Tacking Point by using the same formula Opposite=Tan×Adjacent in the triangles shown in FIG. 2 with angles alpha and beta, knowing that the Opposite is the same in both and defines the latitude (Y value) of the tacking point, so increasing the Adjacent distance on the X axis (longitude) in both until the Opposite side is the same for both;
h. deriving the Y value (latitude) of the tacking point from the length of the Opposite side, in relation to the Y value (latitude) of the current position, and deriving the X value (longitude) of the tacking point from the distance on the Adjacent side from the current position;
i. calculating the distance along each tack using the Pythagorean Theorem to derive the distance diagonally along each hypotenuse or tacking leg, combining the two distances into a total distance.
j. calculating the Completion Time as a function of the distance on both tacks divided by the boat speed;
k. redo the same calculations with the same wind angles if there are multiple wind zones between the current position and the waypoint.

8. The method of sharing wind and GPS data for calculating and displaying standings of sailboats in a race in claim 1, wherein the current boat speed and heading and wind speed and direction, or averages over a specifiable period, are used to assess how long it will take the boat to arrive, and to compare this to other boats' placement.

9. The method of sharing wind and GPS data for calculating and displaying standings of sailboats in a race in claim 1, wherein current boat speed is sufficient for assessing performance and race standings of boats, along with their tacking distances based on the current heading and wind angle, with polar plot data only being needed to compare optimal tacks for an individual sailboat.

10. The method of sharing wind and GPS data for calculating and displaying standings of sailboats in a race in claim 1, wherein users can save polar data into the maps database (boat speed, wind speed and wind angle) along with information including their model of boat, boat length, and boat name, to generate their own polars, share with others with similar models of boat, or for performance comparisons, or the database can save polars on any boats with boat speed, wind speed and wind angle data available, or the database can allow polar data to be edited or imported from other sources.

11. The method of sharing wind and GPS data for calculating and displaying standings of sailboats in a race in claim 1, wherein polar plots are learned by collecting data samples containing wind direction and boat heading (which together give the wind angle), boat speed and wind speed through a method comprising the steps of:
a) monitoring the data continuously, but only saving when the wind speed is constant within a specified range for a specified period of time, the wind angle is not varying by more than a given amount, and the boat speed is constant within a specified range for a specified period of time;
b) using a table of boat speeds as a function of wind speed and wind angle, in which the cells or bins can initially be seeded with data from a generic polar plot;
c) defining the range of boat speed values to catch in each bin, and to minimize any gaps between these intervals, such as one interval up to 15.99 knots and the next beginning with 16.00 knots, so there is no gap that misses data;
d) storing a specified number of the best 1-minute periods observed, with the value for the boat speed in each bin being simply the running average of these best periods;
e) optionally condensing the polar table to only boat speed as a function of wind angle, for users wanting to do initial or quick calculations;
f) using more than one polar plot, for different boats, different sail combinations, for racing versus cruising, or other uses;
g) graphically displaying the table of boat speed as a function of wind speed by wind angle as a polar plot;
h) smoothing the lines, and using data from between the cell-values at each point, by interpolating between the wind angles and wind speeds to get any specific point in the table or graph, using a two-step process in which we interpolate for the boat speed the proportionate distance between the two different wind angles, at the proportionate distance between the two different wind speeds;
i) suspending data collection under certain conditions including when the sailboat is motoring, when the user has good data and wants to use it rather than continue adding to it, when heading into the wind, or when tacking.

12. The method of sharing wind and GPS data for calculating and displaying standings of sailboats in a race in claim 1, wherein we can display each boat in its location on a race map, indicating their standing or projected Completion Time in a list or with a number or color or graphic near or on the boat indicating standings or Completion Times.

13. The method of sharing wind and GPS data for calculating and displaying standings of sailboats in a race in claim 1, wherein wind and race maps, data and footage can be viewed in real-time, or in replays, or in 2D or 3D animations, in which users can click on the boat's graphic or on wind symbols allowing additional data to be viewed from that source, including graphs of wind speed, wind direction and boat speed over time, heeling and moving in waves (including if anemometer on a buoy), and/or a wind direction gauge with numeric wind speed, a wind speedometer with a wind direction arrow around the outside, or a generic wind gauge with the direction being faced at the top of the gauge, with compass and wind direction around it.

14. The method of sharing wind and GPS data for calculating and displaying standings of sailboats in a race in claim 1, wherein GPS tracks and the tack headings can be displayed for one or more boats, with the option to do a small number of long tacks or more shorter tacks on the same headings.

15. The method of sharing wind and GPS data for calculating and displaying standings of sailboats in a race in claim 1, wherein rather than dividing the total distance into cells or isochromes of equal increments, we simply plot current or optimal tack headings in each wind zone that appears on the wind map, so that by checking for changes in the wind angle the wind zones are of dynamic size not equal increments, for calculating and displaying relative standings or Completion Time using networked wind maps, rather than just from a forecast or the anemometer on board.

16. The method of sharing wind and GPS data for calculating and displaying standings of sailboats in a race in claim 1, wherein GPS and wind data is transmitted in real time or stored for later transmission, using an app, or a web browser that supports a geolocation format such as in HTML5, with data transmitted using location and time stamps to make clear if there were any gaps in transmissions

17. The method of sharing wind and GPS data for calculating and displaying standings of sailboats in a race in claim 1, wherein users must register, which allows each to add data for their boat or anemometer, and to have a password and encrypted communications so that their data is secure and not being accessed or edited without authorization, and also allows the user-base to be quantified.

18. The method of sharing wind and GPS data for calculating and displaying standings of sailboats in a race in claim 1, wherein there are quality controls for crowd-sourced data, allowing users or race committees to only select some of data sources, and to see ratings of specific data points or types and brands of anemometers (stationary, on boats, brand, and type such as cup, ultrasonic or propeller).

19. The method of sharing wind and GPS data for calculating and displaying standings of sailboats in a race in claim 1, wherein it is also possible to transmit some other data that could be useful for later evaluation including data on tilt, which helps to assess the accuracy of wind data in different types of anemometers and to assess the performance of sailboats when heeling or in wave-action.

20. The method of sharing wind and GPS data for calculating and displaying standings of sailboats in a race in claim 1, wherein GPS data can be used to indicate if a source is moving or stationary, which can be indicated on the map by the use of different symbols, so that if wind data is coming from a moving source like a boat, the wind data can be converted to true wind, or transmitted this way, with indicators and controls for whether true or apparent wind data is being displayed.
